(19) United States
(12) Patent Application Publication
(10) Pub. No.: US 2010/0252662 A1
(43) Pub. Date: Oct. 7, 2010

(54) Canister Recycling Device

(76) Inventor: Jeffrey M. Beck, Schaumburg, IL (US)

Correspondence Address: COOK ALEX LTD, SUITE 2850, 200 WEST ADAMS STREET, CHICAGO, IL, 60606, US

(21) Appl. No.: 12/752,801

(22) Filed: Apr. 1, 2010

Related U.S. Application Data
(60) Provisional application No. 61/165,951, filed on Apr. 2, 2009.

(51) Int. Cl. B02C 13/00

(52) U.S. Cl. 241/27; 241/185.5

(57) ABSTRACT

A device for crushing a spent beverage canister that comprises a first rotatable member having an axis of rotation and first and second canister engaging portions that revolve around the axis of rotation of the first member as the member rotates. The device also includes a crushing surface adjacent to the first member. As the first member is rotated, the first engaging portion engages a bottom portion of the canister wall and crushes the canister against the crushing surface so that the bottom portion of the canister wall is at least partially crushed inward. As the first member further rotates, the second engaging portion engages a top portion of the canister wall and crushes the canister against the crushing surface so that the top portion of the canister wall is at least partially crushed inward.

The present application claims the benefit of U.S. Provisional Patent Application Ser. No. 61/165,951 filed Apr. 2, 2009 and is hereby incorporated herein by reference.

### FIELD OF INVENTION

The present disclosure is related to devices and methods for collecting and recycling post consumer goods. More particularly, the present disclosure is related to collecting and crushing spent beverage canisters, such as aluminum cans and plastic bottles.

### BACKGROUND

An uncrushed aluminum can takes up a volume of about approximately 528 cubic centimeters, 97% of which is air. In commercial or public facilities, such as an office building, school, parks, etc., aluminum cans are typically collected for recycling by the traditional method of collecting uncrushed used or spent cans in a trash receptacle, such as a garbage can. A conventional garbage can holds approximately 300 uncrushed can, which is about five dollars worth of aluminum. Using such traditional collection and recycling methods, most commercial building cannot collect and/or store enough cans to make recycling profitable. Additionally, waste management services also struggle to be profitable as a result of the collection of uncrushed cans.

There remains a need for a more efficient and cost effect method and apparatus for collecting and recycling aluminum cans.

### SUMMARY OF INVENTION

In one aspect, the present disclosure is directed to an apparatus that crushes spent beverage cans, such as aluminum cans or plastic water bottles, for efficient and cost effective recycling. In one embodiment, the apparatus also stores the crushed beverage canisters. Such apparatus can be located in any number of locations, for example, public and private use in schools, colleges, hospitals, office buildings, street corners (solar powered) or virtually any other places where aluminum cans are used and can be collected.

One aspect of the present disclosure is a device for crushing a spent beverage canister that comprises a first rotatable member having an axis of rotation and first and second canister engaging portions that revolve around the axis of rotation of the first member as the member rotates. The device also includes a crushing surface adjacent to the first member. As the first member is rotated, the first engaging portion engages a bottom portion of the canister wall and crushes the canister against the crushing surface so that the bottom portion of the canister wall is at least partially crushed inward. As the first member further rotates, the second engaging portion engages a top portion of the canister wall and crushes the canister against the crushing surface so that the top portion of the canister wall is at least partially crushed inward.

Another aspect relates to a device for crushing spent canisters including a housing defining an interior region. The housing includes a top wall defining an opening that receives spent canisters. The device includes a first rotatable member having an axis of rotation and first and second canister engaging portions that evolve around the axis of rotation of the first member as the member rotates. Further, the device includes a crushing surface adjacent to the first member. As the first member is rotated, the first engaging portion engages a bottom portion of the canister wall and crushes the canister against the crushing surface so that the bottom portion of the canister wall is at least partially crushed inward. As the first member further rotates, the second engaging portion engages a top portion of the canister wall and crushes the canister against the crushing surface so that the top portion of the canister wall is at least partially crushed inward.

Yet another aspect relates to a method of crushing a spent beverage canister including engaging a bottom portion of canister with a first portion of a crushing member. The bottom portion is crushed with the first portion so as to fold the bottom of the canister upward and toward the middle of the canister. A top portion of the canister is then engaged by a second portion of the crushing member. The second portion crushes the top portion so as to fold the top of the canister downward and toward the middle to the canister. The canister is then further crushed so that the top and bottom of the canister are further folded toward the middle portion of the canister.

### BRIEF DESCRIPTION OF THE DRAWINGS

FIG. 1 is a perspective view of one embodiment of a housing of a recycling device in accordance with the present disclosure;

FIG. 2 is a cross-sectional view of the upper lid of the housing of FIG. 1, showing one embodiment of a canister crushing mechanism;

FIG. 3 is a plan view of the canister crushing mechanism shown in FIG. 2;

FIG. 4 is a perspective view of another embodiment of a canister crushing mechanism, shown within the upper lid of the housing of FIG. 1;

FIGS. 5A-5D illustrate one embodiment of a sequence of crushing a canister with the canister crushing mechanism of FIG. 4;

FIG. 6 is a cross-sectional view of another embodiment of a recycling device;

FIG. 7 is a perspective view of the crushing mechanism of the recycling device of FIG. 6;

FIGS. 8 and 9 illustrate one embodiment of a sequence of crushing a canister with the canister crusher of FIG. 7;

FIG. 10 is a perspective view of another embodiment of a recycling device;

FIG. 11 is cross-sectional view of the housing of the recycling device of FIG. 10, showing another embodiment of a canister crushing mechanism therein;

FIG. 12 is across-sectional view of the crushing member of FIG. 11;

FIG. 13 is a perspective view of the crushing member of FIG. 11; and

FIGS. 14-21 illustrate one embodiment of a sequence of crushing a canister with the canister crushing mechanism of FIG. 10.

### DETAILED DESCRIPTION

Referring to FIG. 1, the illustrated collection or recycling device 8 may have a configuration similar to that of a waste collection container, such as a large garbage can or waste receptacle. In other embodiments, the collection container may have other configurations that may be smaller or larger in size and/or round or polygonal depending on the desired application. The recycling device 8 includes an upper lid or unit 10 and a lower storage unit 12, which receives and stores post-consumer or spent canisters that are inserted into the device.

The upper lid 10 has an opening 16 for receiving therein spent canisters, such as aluminum cans, plastic bottles, steel cans and the like. The opening 16 may be shaped or include a blocking device, such as a slotted plastic cover, that prevents or blocks the insertion of undesired objects into the opening 16. Further, the opening 16 also may be configured or include a device that is designed to slow the insertion of the spent canisters into the opening. Additionally, opening 16 may be configured to selectively accept only certain types of canisters. For example, opening 16 may be configured to accept only aluminum cans.

Optionally, opening 16 is in communication with passageway 18 that allows spent canisters to pass through the lid 10 and directs the canister toward a crushing mechanism or element (not shown in FIG. 1), such as any of the crushing mechanisms shown herein. In the illustrated embodiment, the passageway 18 is defined by a generally cylindrical hollow tube 19 that extends downward from opening 16 and into the interior of device 8. When tube 19 is utilized, the tube may extend downward from opening 16 and terminate at a location closely adjacent to the crushing mechanism. Furthermore, tube 19 may have an angled or tapered terminal end 21 which allows the terminal end to be place close to the crushing mechanism without interfering with the operation of the crushing mechanism.

The device 8 also may include additional features such as those that secure the lid 10 to the storage unit 12. For example, either the lid 10 or storage unit 12 may include a locking member or members, such as lock 14, that locks the lid 10 to the storage unit 12. Such locking members can be employed to stabilize the lid 10 on the storage unit 12 or the locking member can be designed to prevent theft and/or vandalism. In other embodiments, the device 8 may have screws, bolts, and hinges that secure the lid 10 to the lower storage unit 12. The recycling device 8 may also include an inlay 20 for the placement of adhesive/removable graphics for advertising.

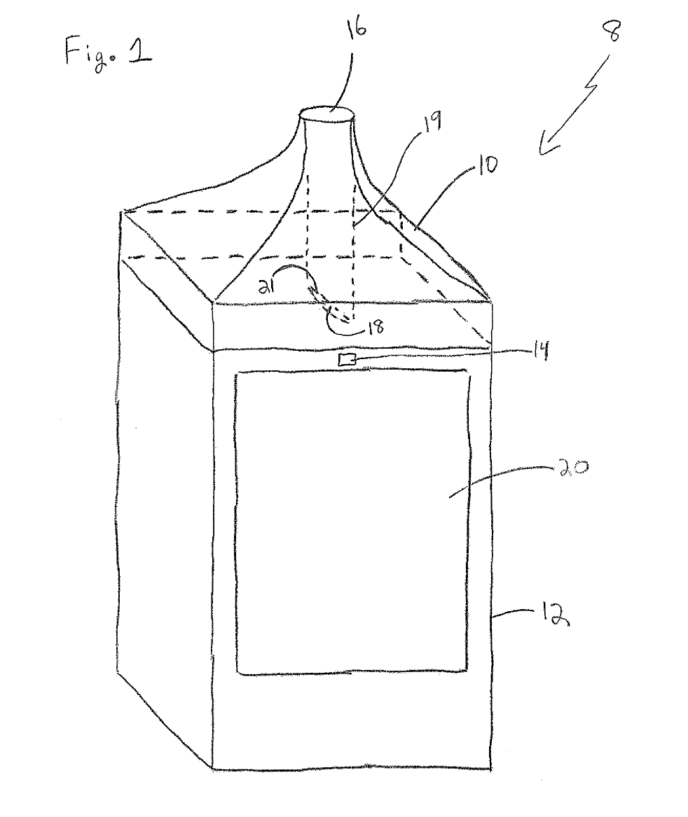

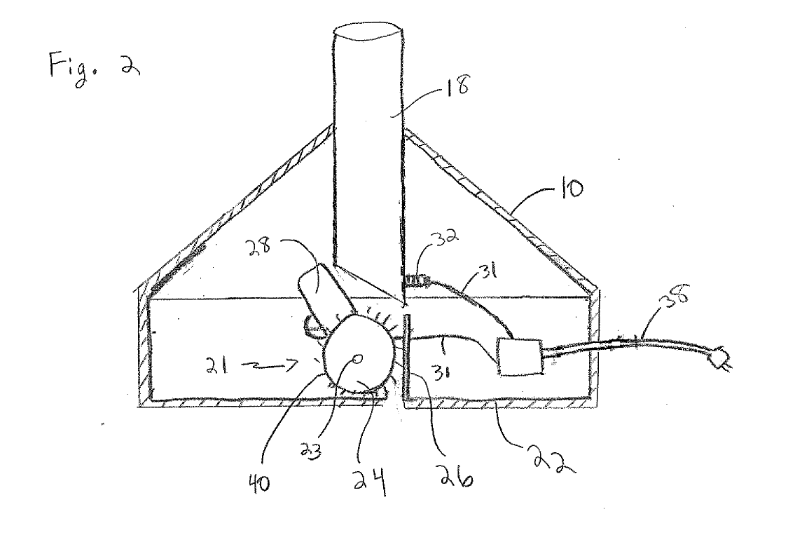

Turning to FIG. 2, there is shown one embodiment of lid 10 having a crushing mechanism 21 associated therewith. The crushing mechanism may be attached to a platform or bottom wall 22 of lid 10. As shown in FIGS. 2 and 3, the crushing mechanism 21 may include a rotatable member, such as the illustrated rotatable crushing member 24. The crushing member 24 may have a substantially cylindrical shape and include projections 40 or other surface deviations for engaging a spent canister. The crushing member 24 is operatively connected to a motor 28 that rotates the rotatable crushing member 24. For example, the crushing member 24 may include a shaft 23 that is operatively connected to and rotated by the motor 28. The motor 28 may be operatively connected to a canister detector 32 and, optionally, to a timer 30, such as a timed relay. The motor 28, canister detector 32 and timer 30 may be connected by electrical wires 31 or may be in wireless communication. Further, the crushing mechanism 21 may be powered through power cord 38. Alternatively, the crushing mechanism may be powered by a battery or solar power. In another alternative embodiment, the motor 28, detector 32 and timer 30 may be eliminated, and the crushing mechanism 24 may be rotated manually, for example, by a hand crank.

Referring to FIG. 2, when a post-consumer or spent canister slides down the feeder tube 18, the detector 32 detects the canister. Canister detector 32 may be any suitable detector which can detect a canister within feeder tube 18. For example, the canister detector 32 may be a motion detector, an optical detector, an electrical detector or mechanical detector. For example, detector 32 may be a mechanical switch that is contacted by the canister. The detector 32 activates motor 28 to drive or rotate the crushing member 24. As the crushing member 24 rotates, projections 40 engage the canister and begin to pull the spent canister down between the crushing member 24 and a crushing plate 26, which is fixed at a distance from the crushing member 24 to achieve the desired dimension of the crushed canister. In one embodiment the distance between the crushing member 24 and crushing plate 26 is about 0.25 inches. However this distance may be larger or small depending on the desired application. In other embodiments, the crushing plate 26 may be the sidewall of the lid 10, or may be an additional crushing drum.

When a timer 30 is employed, the canister detector 32 activates the motor 28 through the timer 30, the timer will power the motor 28 for a prescribed amount of time, for example, approximately five second or however long it takes for the canister to be fully pulled through the gap between the crushing member 24 and the crushing plate 26. After the canister has left feeding tube 18, the canister detector 32 will look for another canister. If only one canister has been placed into the feeding tube 18 and a second or subsequent canister is not present within the feeding tube 18, the motor 28 will stop at the end of the prescribed time period. Conversely, if a second canister is detected by the detector 32, the detector will activate the timer 30 and the motor 28 will continues to operate.

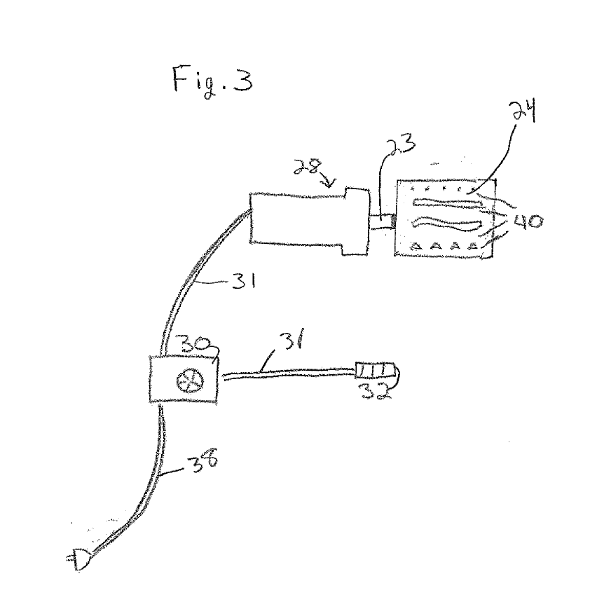

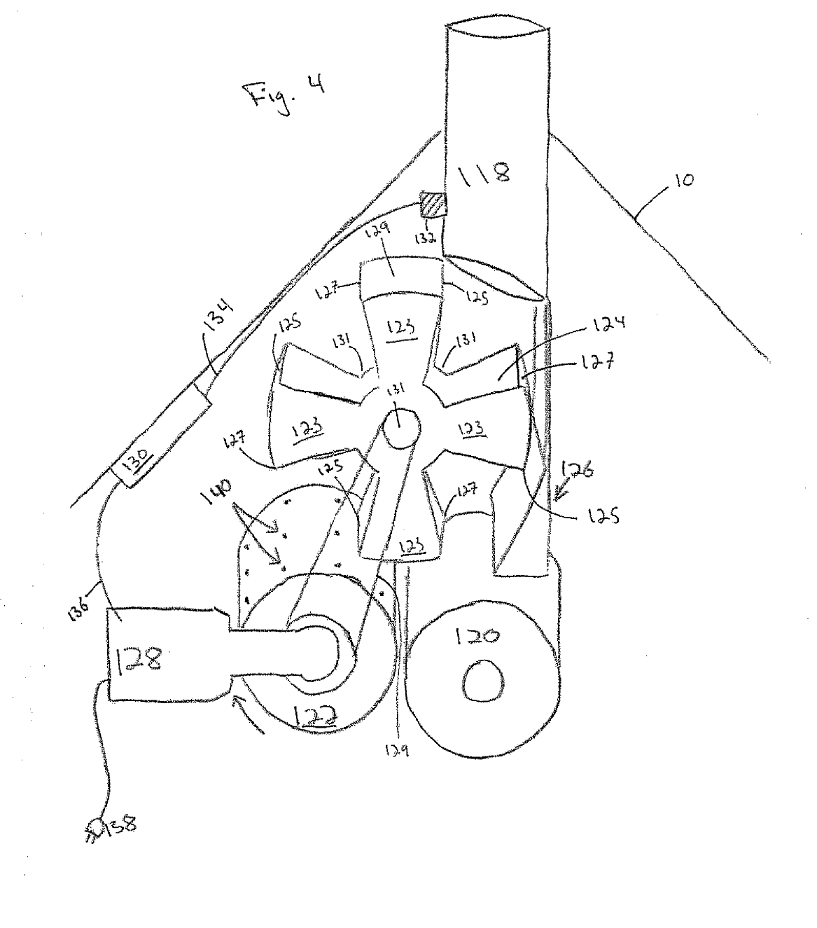

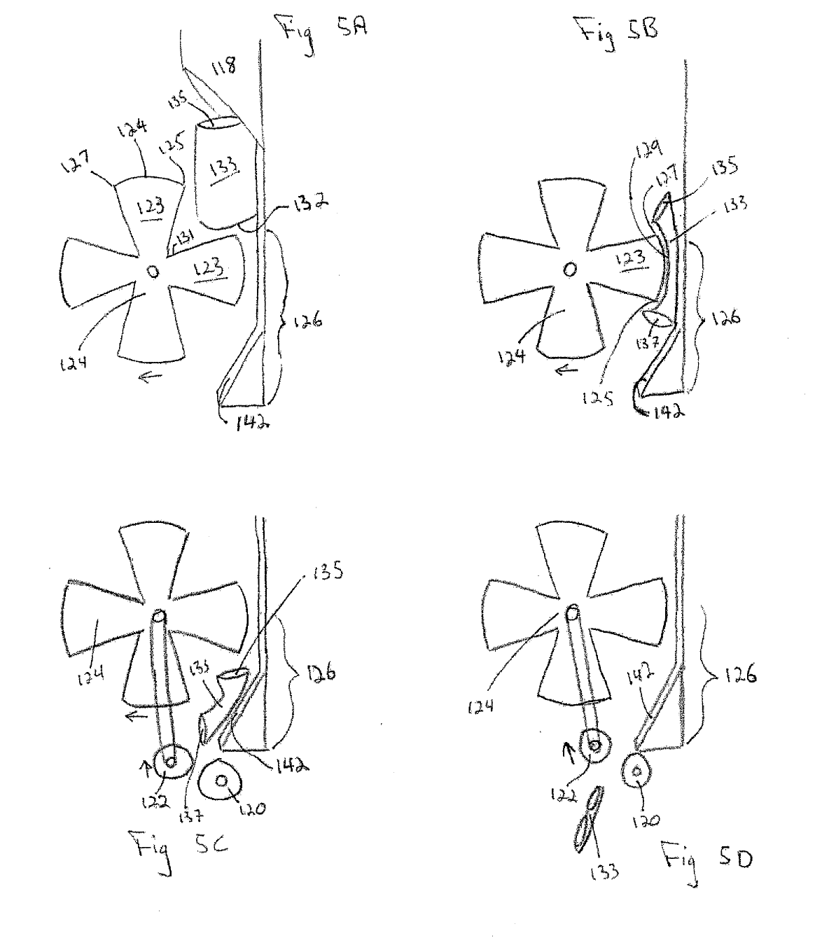

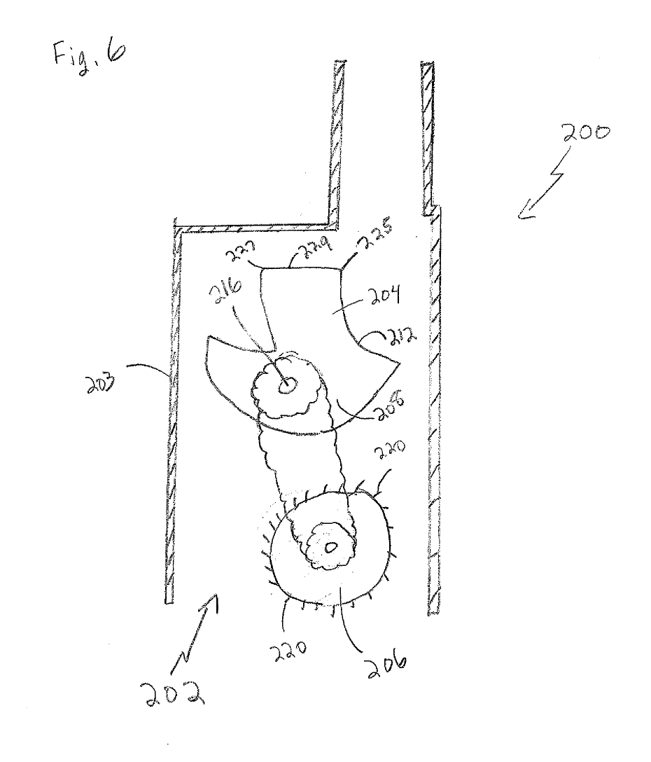

FIG. 4 illustrates another embodiment of a crushing mechanism 121 which may be located within lid 10 of the recycling device 8. The crushing mechanism 121 includes a primary crushing member, such as rotatable crushing member 124. Optionally, crushing mechanism 121 includes a secondary crushing member, such as rotatable crushing member 122. Rotatable crushing member 124 has a cruciform configuration with a plurality of radially extending wings 123. The crushing member 124 rotates about an axis 131. Each wing includes first engaging or crushing portion 125, a second engaging or crushing portion 127 and a crushing surface 129 therebetween. In the illustrated embodiment, the first and second engaging portions 125 and 127 comprise the edges of mating surfaces. Additionally, the first and second engaging portions rotate around axis 131 as the crushing member rotates. As explained in more detail below with respect to FIGS. 5A-5D, when a spent canister is present and the crushing member 124 is rotated, the first engaging portion 125 engages a bottom portion of a spent canister and crushes it against a crushing plate 126. The crushing surface 129 contacts and crushes the middle portion of the spent canister against the crushing plate 126 and the second engaging portion 127 engages and crushes a top portion of the canister against plate 126.

Similar to the previous embodiment, the crushing mechanism 121 may also include a motor 128, a timer 130 and a canister detector 132. The motor 128 is operatively connected to the rotatable crushing member 124 and causes it to rotate. In the illustrated embodiment, the motor 128 is operatively connected to the secondary crushing member 122 and when the motor 128 is activated, it rotates secondary crushing member 122. The secondary crushing member 122 is operatively connected to a primary crushing member 124 by a drive member 129, which may be, for example, a chain, belt, direct gear or the like. As the secondary crushing 122 member is rotated, it drives the drive member 129, which rotates primary crushing member 124.

Further, the motor 128 may be operatively connected to a canister detector 132 and optionally to a timer 130 by wires 134 and 136. When a spent canister is inserted into the feeder tube 118, canister detector 132 detects the canister and activates the motor 128 to rotate secondary crushing member 122, which drives the drive member 129 to rotate primary crushing member 124. When the detector 132 activates the motor 128 through the timer 130, the timer will power the motor for a prescribed amount of time, approximately five second or however long it takes for the canister to be fully pulled between the primary crushing member 124 and the crushing plate 126 and then between the secondary crushing member 122 and crushing surface 120. After a canister has passed through feeding tube 118, the detector 132 will look for another canister. If no canister is present, the motor 128 will stop after the prescribed time. If a second canister is present, the detector 132 will activate the motor 128 and the motor will continue to run.

Referring to FIG. 5A, as a canister 133 comes out the bottom of the feeder tube 118, it falls into the gap 131 between two of the adjacent wings 123 of primary crushing member 124. As the primary crushing member 124 begins to rotate, the first engaging portion 125 of wing 123 contacts and crushes a bottom portion of the canister 133 against a crushing plate or surface 126, thereby bending or folding the canister 133 so that the bottom surface 135 of the canister 133 is bent at an angle or folded upward. As the primary crushing member 124 is further rotated, the crushing surface 129 of the crushing member 124 contacts and crushes the middle portion of canister 133 against crushing plate 126, as shown in FIG. 5B. The primary crushing member 124 is then further rotated so that engaging portion 127 engages and crushes a top portion of canister 133 against crushing plate 126, thereby bending or folding the top 137 of the canister 133 at an angle or folded downward. The primary crushing member 124 is further rotated to drop the canister 133 downward toward the secondary crushing member 122. The crushing mechanism 121 may included a guide, such as angled surface 142 to guide the crushed canister 133 toward secondary crushing member 122.

As shown in FIG. 5D, the secondary crushing member 122 crushes the canister 133 against a second crushing surface 120. The second crushing member 122 may be substantially cylindrically shaped and have projections 140 (FIG. 4) or other surface deviations that engage the canister 133 and pull it between the secondary crushing member 122 and the crushing surface 120. The secondary crushing member 122 and the crushing surface 120 are located a distance from one another to achieve the desired size of the resulting crushed canister. In one embodiment, the distance between the secondary crushing mechanism 122 and the crushing surface 120 is about 0.375 inches. However, this distance can be larger or small depending on the desired application.

In the illustrated embodiment, crushing surface 120 is a rotatable cylindrically shaped member. In other embodiments, the crushing surface 120 could be a plate or a sidewall of the lid 10. After the canister 133 has passed between the secondary crushing member 122 and crushing surface 120, the canister will be folded or crushed so that the top 137 and bottom 135 of the canister 133 are folded toward the middle of the canister, as shown in FIG. 5D. The crushed canister 133 may then fall into the lower unit 12 (FIG. 1) for storage.

Each wing 123 of the primary crushing member 124 crushes one canister at a time. When a subsequent canister is located within feeding tube 118, the crushing surface 129 of the adjacent wing 123 rides along the bottom of the canister and maintains the canister within the tube 118 until the primary crushing member 124 further rotates and the subsequent canister is allowed to drop into the next gap 131 between adjacent wings.

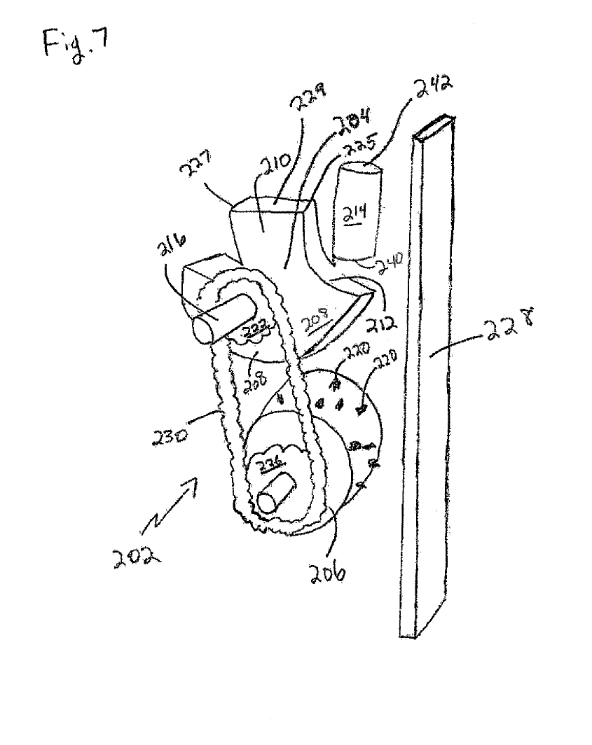

FIGS. 6-9 illustrate another embodiment of a recycling device 200, which includes a crushing mechanism 202 within a housing 203. The crushing device 200 may be mounted within a lid of a recycling device, mounted or situated above a garbage or waste container, or attached to a surface, such as a wall. Referring to FIGS. 6 and 7, the crushing mechanism 202 includes a primary crushing member 204 and, optionally, a secondary crushing member 206. The first crushing member 204 is generally “T” or mushroom shaped and includes a base 208 and a leg or projection 210 extending from the base. In the embodiment shown, the leg 210 extends generally vertically upward from the base when the crushing member is in the initial or starting position.

A shoulder 212 for receiving a spent canister 214 is defined between the base 208 and leg 210. In the embodiment shown, a shaft 216 extends from the crushing member 204. The shaft 216 may be rotated by, for example, a motor or a hand crank (not shown). The rotational movement of the shaft 216 is transferred to the crushing member 204 to rotate the crushing member. The primary crushing member 204 includes a first engaging or crushing portion 225, a second engaging or crushing portion 227 and a crushing surface 229 therebetween. In the illustrated embodiment, the first and second engaging portions 225 and 227 comprise longitudinally extending edges of mating surfaces. As explained in more detail below with respect to FIGS. 7-9, when a spent canister 214 is present and the crushing member 224 is rotated, the first engaging portion 225 engages a bottom portion of the spent canister and crushes it against a crushing plate 228, thereby folding the bottom portion of the canister so that the bottom of the canister is bent upward. The crushing surface 229 contacts and crushes the middle portion of the spent canister against the crushing plate 228 and the second engaging portion 227 engages and crushes the top portion of the canister against plate 128, thereby folding the top portion of the canister so that the top of the canister is bent downward toward the middle of the canister.

In the illustrated embodiment, the secondary crushing member 206 has a generally cylindrical shape, which may be a solid or hollow drum or which may be a plurality of side-by-side washers, sprockets or gears. The secondary crushing member 206 also may have other shapes and/or be constructed of a variety of components. The secondary crushing member 206 also may include projections 220, such as spikes, extending from the surface of the secondary crushing member. As explained below, the projections 220 engage or grab a canister that comes into contact with the crushing member 206.

In the embodiment shown, the primary crushing member 204 and the secondary crushing member 206 may be operatively connected so that they rotate simultaneously. In other embodiments, the primary and secondary crushing members 204, 206 may rotate independently of each other. A drive shaft, such as sprocket 222, associated with the primary crushing member 204 is attached to and rotates with the shaft 216. The secondary crushing member 206 also includes a drive shaft, such as sprocket 226, attached thereto. Sprocket 222 and sprocket 226 are operatively connected by a drive means so that as sprocket 222 is rotated, sprocket 226 is also rotated. In the embodiment shown, the sprockets are connected by chain 230. The sprockets also may be connected by, for example, a drive belt.

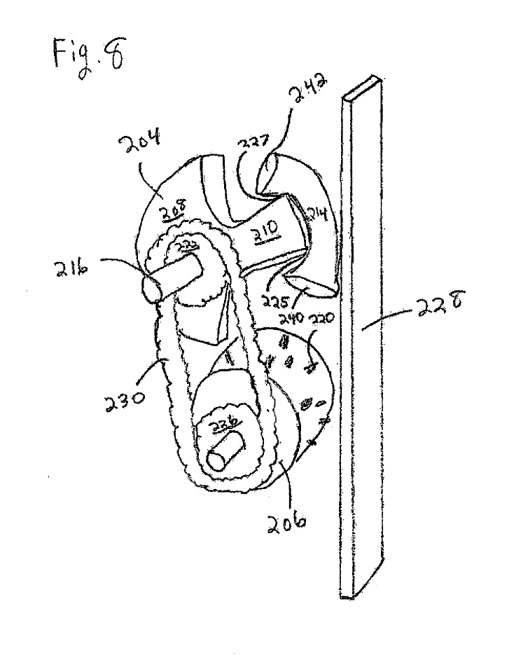

Referring to FIG. 7, in use, a canister 214 inserted into recycling device 200 is received on shoulder 212 of the primary crushing member 204. Referring to FIG. 8, as primary crushing member 204 is rotated, the first engaging portion 225 of the primary crushing member 204 engages a bottom portion of the canister at a location that is between about 0.5 inches to about 2.5 inches from the bottom of the canister. Preferably, the first engagement portion engages the canister at a location that is about 1 inch from the bottom of the canister. The first engagement portion 225 crushes the bottom portion of the canister against crushing surface 228 so that bottom portion of the canister folds and the bottom 240 of the canister 214 is bent upward toward the middle of the canister. As the primary crushing member 204 is further rotated, the crushing surface 229 engages the middle portion of the canister 214 and crushes it against crushing surface 228. The primary crushing member 204 is further rotated so that the second engaging portion 227 engages a top portion of the canister of the canister at a location that is between about 0.5 inches to about 2.5 inches from the top of the canister. Preferably, the second engagement portion 227 engages the canister at a location that is about 1 inch from the top of the canister. The second engagement portion 227 crushes the top portion of the canister against crushing surface 228 so that top portion of the canister folds and the top 242 of the canister 214 is bent downward toward the middle of the canister.

Referring to FIG. 9, after the canister 214 has been crushed and folded, the primary crushing member 204 is further rotated so that the canister disengages from the primary crushing member 204 and engages second crushing member 206. Preferably, the canister 214 is allowed to fall under the influence of gravity onto the second crushing member 206. The projections 220 of the second crushing member 206 engage or grasp the canister 214 to pull the canister downward and further crush the can between the crushing member and crushing surface 228. The secondary crushing member is rotated until the canister 214 disengages and falls from the second crushing member 206, preferably into a collection container, such as the collection containers described above.

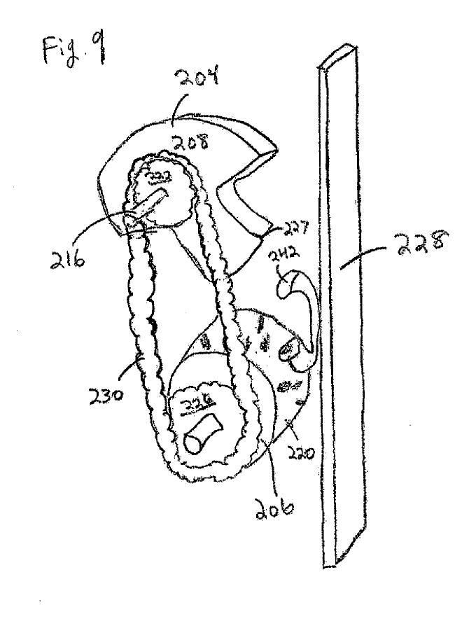

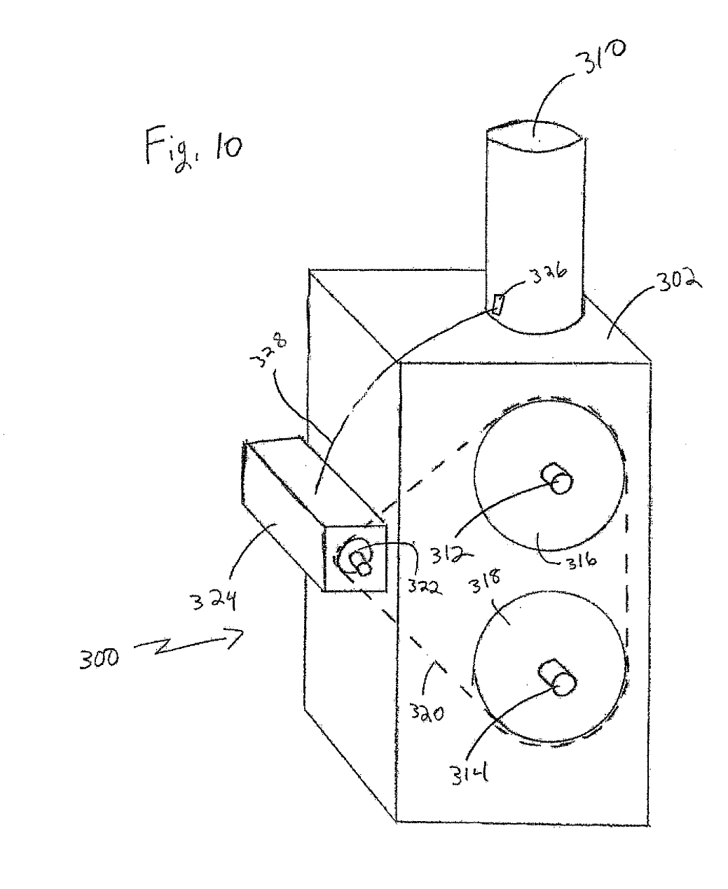

FIGS. 10 and 11 illustrate another embodiment of a recycling device 300, which includes a housing 302 that defines an interior containing a canister crushing mechanism 304 (FIG. 11). The housing 302 also includes an opening 310 for receiving canisters into the interior of the housing. The recycling device 300 may be located within a lid of a recycling collection unit, such as lid 10 described above. Alternatively, the recycling device may be designed to be positioned or stabilized above a garbage or waste collection can, or the device 300 may be mounted to a surface, such as a garage wall.

Referring to FIG. 11, the crushing mechanism 304 includes a primary rotatable crushing member 306. In the illustrated embodiment, the crushing mechanism 304 also includes a secondary crushing member 308, which is an optional feature and which also may be a rotatable crushing member, for example, any of the secondary rotatable crushing members described above. When both a primary rotatable crushing member 306 and a secondary rotatable crushing member 308 are employed, the rotatable members may be operatively connected so that they rotate simultaneously. Alternatively, the primary and secondary crushing member may rotate independently of each other.

In the illustrated embodiment, each of the primary and secondary crushing members 306 and 308 include a shaft 312 and 314, respectively. Referring to FIG. 10, the shafts 312 and 314 each may have a drive shaft 316 and 318, respectively, attached thereto. The drive shafts may be, for example gears or sprockets. Further, the drive shafts 316 and 318 may be operatively connected by a drive member 320, such as a drive belt or a drive chain. The drive member 320 may be operatively connected to a drive shaft 322 of a motor 324, wherein the motor 324 is activated to rotate the drive shaft 322 to drive the drive member 320 to rotate the first and secondary crushing members 306 and 308. Additionally, similar to the embodiments described above, the device 300 may include a canister detector 326 which may be located near the opening 310 of housing 302. The canister detector 326 may be any of the detectors described above and may be connected to the motor 324 by wire 328 or may be in wireless communication with the motor 324. When the canister detector 326 detects a canister it actives the motor 324. Additionally, the device 300 may include a timer, such as any of the timers discussed above, that activates the motor 324 for a pre-selected period of time. In the illustrated embodiment, the components of the drive system are located on the outside of the housing 302. However, the components also may be located on the inside of the housing 302.

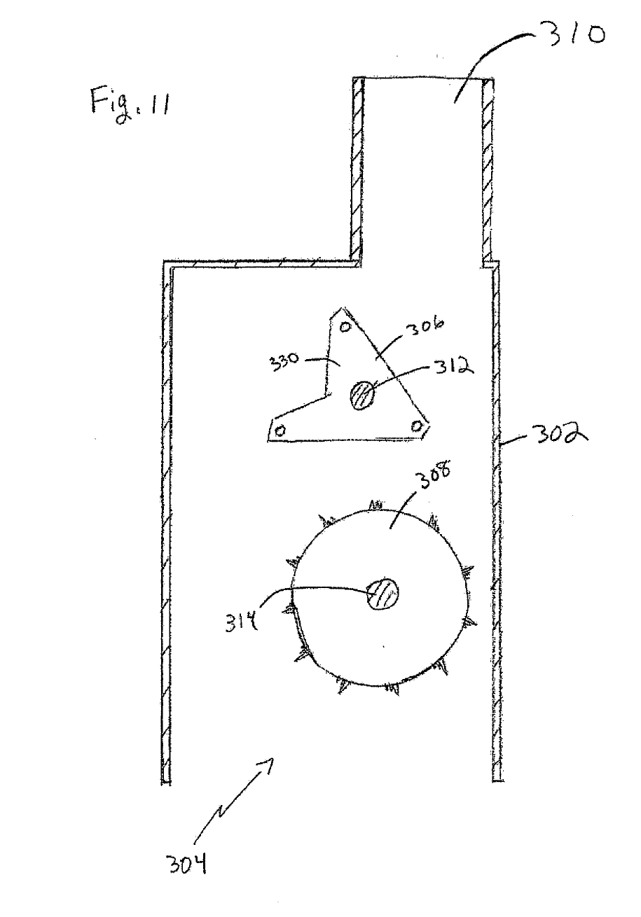

Turning to FIGS. 12 and 13, the primary crushing member 306 includes first and second endplates 330 and 332. In the embodiment shown, the first and second endplates 330 and 332 are generally triangularly shaped. However, the endplates 330 and 332 may also have different shapes, such as for example, round, square or rectangular. Extending between the endplates 330 and 332 are a first shaft or first canister engagement portion 334 and a second shaft or second canister engagement portion 336. Optionally, the primary crushing member 306 may include a third shaft or third canister engagement portion 338 and a fourth shaft or canister pusher 340. The first, second and third shafts 334, 336, and 338, when a third shaft is present, are arranged in a generally triangular configuration. Additionally, the first shaft 334 is positioned so that it engages a bottom portion of a canister inserted into the opening 310 of the housing 302. The first shaft 334 engages the bottom portion of the canister at a location that is between about 0.5 and 2.5 from the bottom of the canister. The second shaft 336 is spaced a distance from the first shaft 334 so that as the crushing member 306 is rotated, the second shaft engages a top portion of the canister at a location that is between about 0.5 and 2.5 from top of the canister. In one embodiment, the second shaft 336 is spaced a distance of about 1.5 to about 4 inches from the first shaft 334, and in another embodiment it is spaced about 1.875 inches from the first shaft 334. The distance between the first and second shafts 334 and 336 may be a greater or lesser distance depending on the application and the size of the canister to be crushed. When a third shaft 338 is used, the third shaft is spaced from the first and the second shafts 334 and 336 so that the third shaft 338 engages the top of the canister. In one embodiment, the third shaft 338 is spaced a distant of between about 1 and about 4 inches from the second shaft 336 and a distance of between about 1.5 and about 4 from the first shaft 334. These distances may be more or less depending on the application and the size of the canister to be crushed. In another embodiment, the third shaft 338 is spaced about 1.625 inches from the second shaft 336 and about 1.875 inches from the first shaft 334. In the illustrated embodiment, the fourth shaft 340 is spaced about 0.375 to about 1.25 inches from the third shaft 338. In another embodiment, the fourth shaft is spaced about 0.625 inches from the third shaft 338.

The plates and shafts may be made out of any hard material, such as metal, wood or a hard polymer. The shafts may be integral with the plates or wielded to the plates. Further, in one embodiment, the shafts may be bolts that are threaded on each end to receive nuts to secure the shafts to the plates. Drive shaft 312 also may extend between and through the endplates 330 and 332. In an alternative embodiment, drive shaft 312 does not extend between the plates but only extends from the outer face of endplate 330. As shown in FIG. 13, the primary crushing member 306 is designed to rotate in a clockwise direction about axis 340. As the crushing member 306 rotates, the shafts 334-338 also rotate about axis 342.

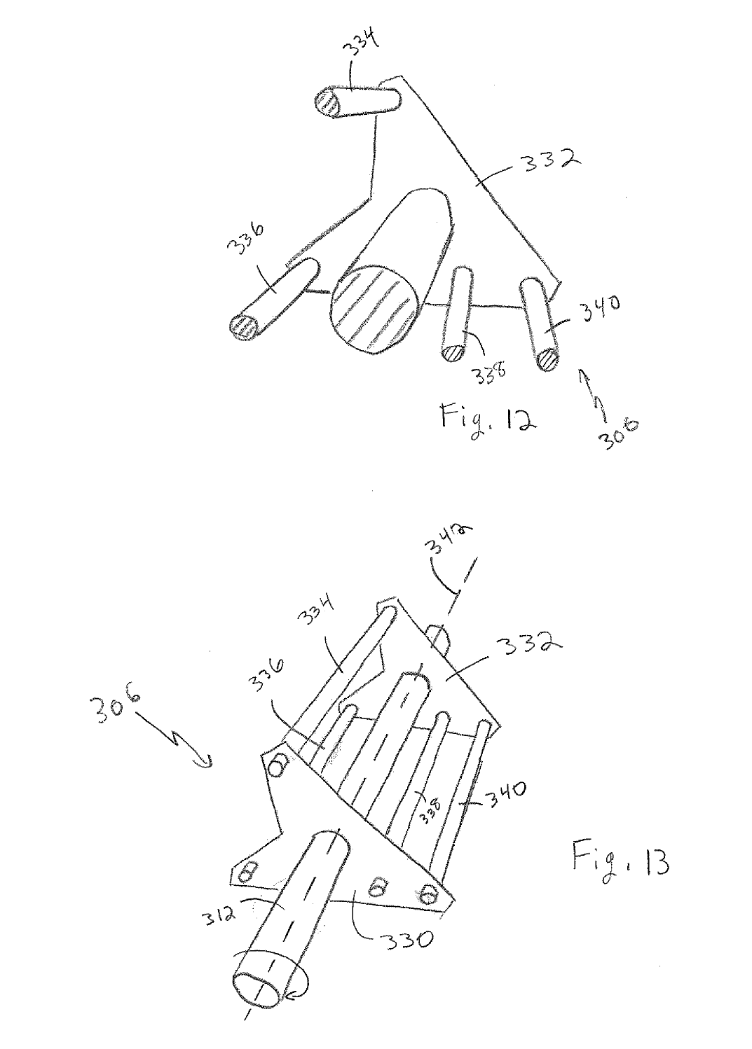

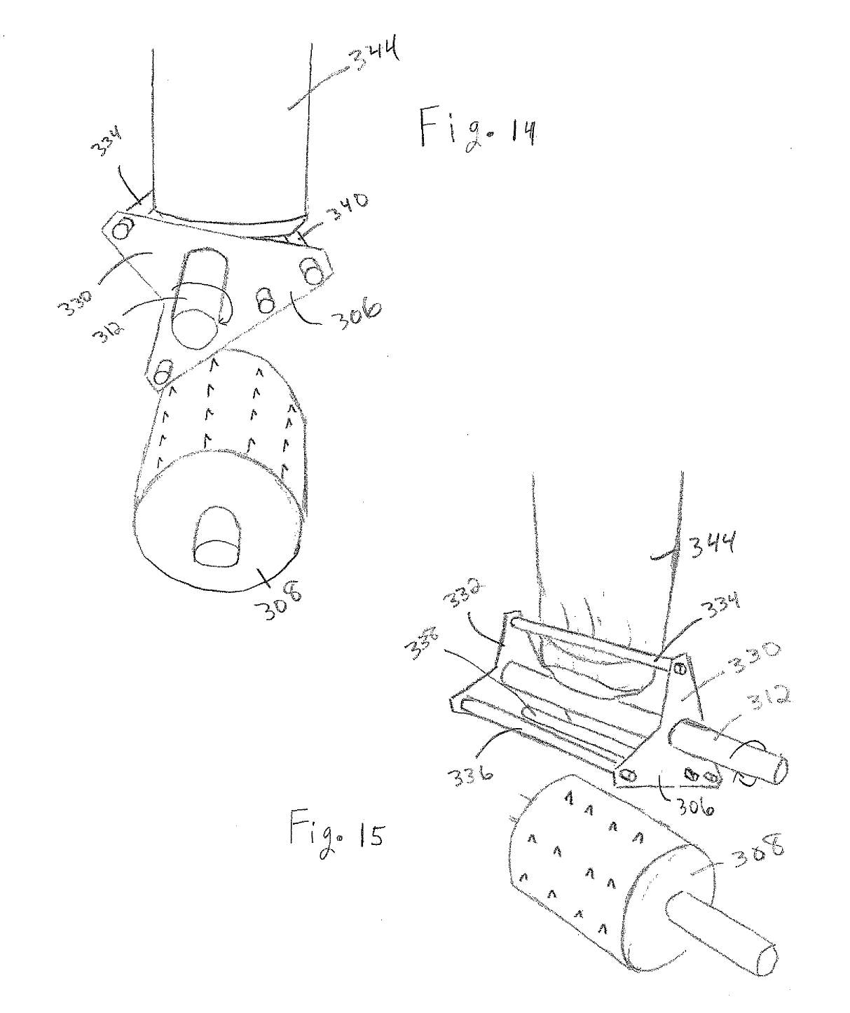

FIGS. 14-21 illustrate one sequence of crushing and folding a canister 344 with the crushing member 306. Referring to FIG. 14, the canister 344 is inserted into the opening 310 of housing 302 (FIG. 10) and rests between first shaft or engagement portion 334 and the fourth shaft 340. Referring to FIG. 15, as the primary crushing member 306 is rotated, the first shaft 334 engages and crushes a bottom portion of the canister 344 against a crushing surface (not shown), which may be an inside surface of housing 302. As the first shaft 334 crushes the bottom portion of the canister 344, the bottom portion is at least partially folded and the bottom 346 of the canister is folded upward as shown in FIG. 16.

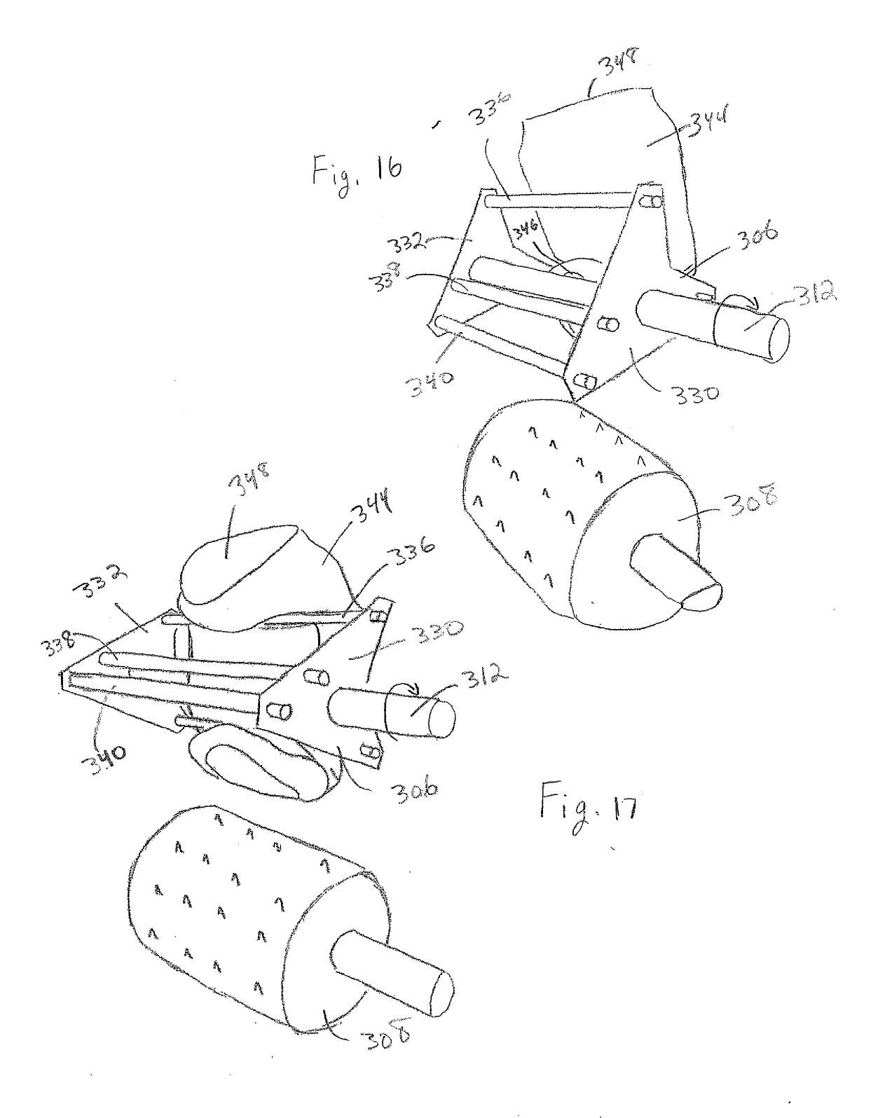

Turning to FIG. 17, the primary crushing member 306 is further rotated and the second shaft or engagement portion 336 engages and crushes a top portion of the canister 344 against the crushing surface (not shown). As the second shaft 336 crushes the top portion of the canister 344, the top portion of the canister 344 is at least partially folded so that the top 348 of the canister 344 is folded downward. As shown in FIG. 18, as the crushing member 306 is further rotated, the third shaft or engagement portion 338 engages the top 348 of the canister 344 and bends or folds the top 348 further downward. At this point, if a canister detector 326 (FIG. 10) and a timer are employed, the timer may be programmed to turn off the motor 324 and suspend operation of the recycling device 300 until the detector 326 detects a second or subsequent canister inserted into opening 310. When the second canister is detected, motor 324 is again activated and operation of the device 300 resumes.

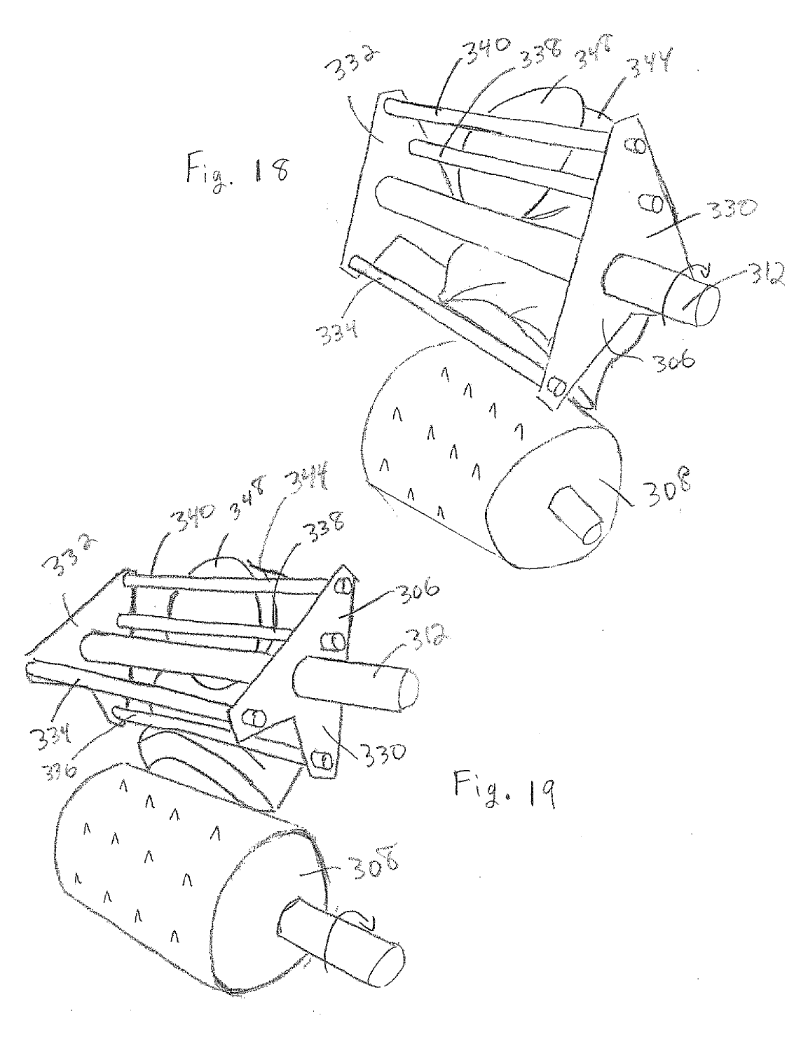

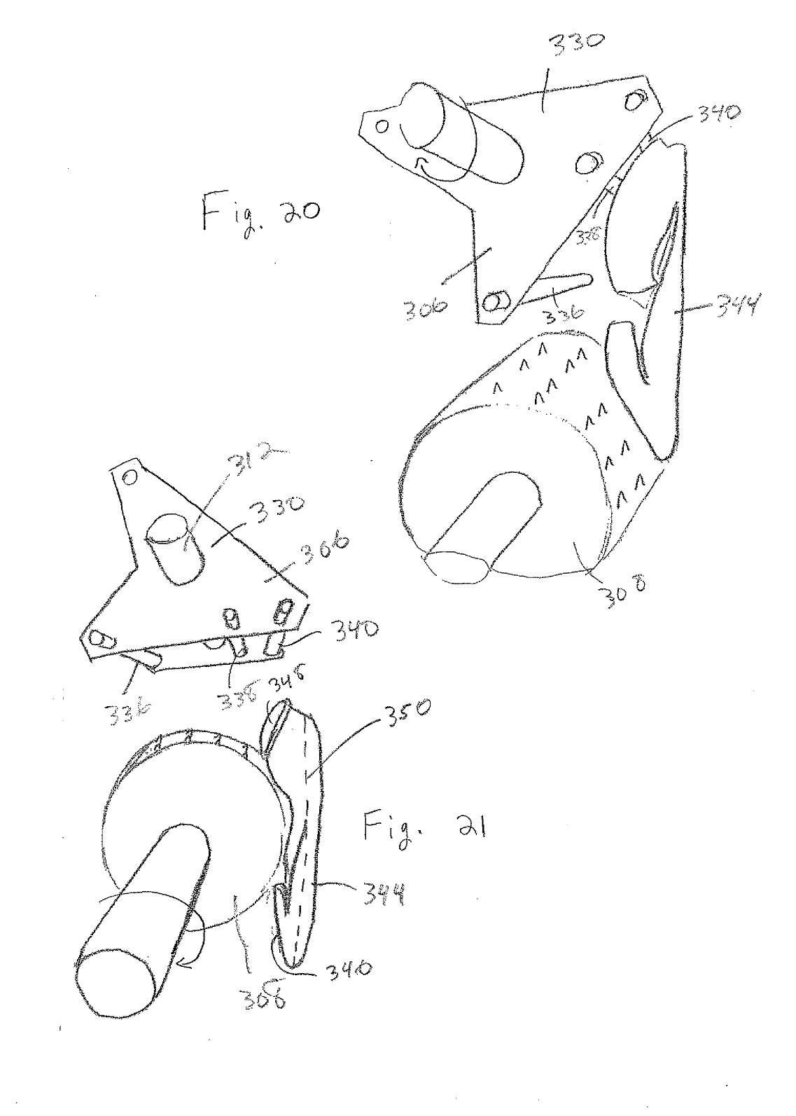

Referring to FIGS. 19 and 20, as the primary crushing member 306 continues to rotate, the fourth shaft or pushing member 340 contacts the top 348 of the canister 344 and pushes the folded or at partially folded canister 344 downward and off of or away from the primary crushing member 306. Referring to FIG. 21, when a secondary crushing member 308 is employed, the canister 344 falls and contacts the secondary crushing member 308 and the secondary crushing member crushes the canister against the crushing surface (not) shown. As shown in FIG. 21, the canister 344 is now folded substantially flat along its longitudinal axis 350.

Although the present invention is described in light of the illustrated embodiments, it is understood that this for the purposes illustration and not limitation. Other applications, modifications or use of the invention may be made without departing for the scope of this invention, as set forth in the claims now or hereafter filed.

I claim:

1. A device for crushing a spent beverage canister, the canister having a top, a bottom and a wall extending therebetween, the device comprising:
a first rotatable member having an axis of rotation and first and second canister engaging portions, wherein the engaging portions revolve around the axis of rotation of the first member as the member rotates;
a crushing surface adjacent to the first member; and
wherein as the first member is rotated, the first engaging portion is adapted to engage a bottom portion of the canister wall and crush the canister against the crushing surface so that the bottom portion of the canister wall is at least partially crushed inward, and as the first member further rotates, the second engaging portion is adapted to engage a top portion of the canister wall and crush the canister against the crushing surface so that the top portion of the canister wall is at least partially crushed inward.

2. The device of claim 1 further wherein the first member includes a third engaging portion, and as the first member further rotates, the third crushing portion contacts the top of the canister to further crush the canister.

3. The device of claim 2 in which the first member further includes a pushing portion that pushes the canister in a direction away from the first member after the canister has been crushed by the third engagement portion.

4. The device of claim 1 wherein the first and second engagement portions comprise spaced apart elongated shaft.

5. The device of claim 1 wherein the first and second engagement portions each comprise an edge of mating surfaces wherein the edges extend longitudinally.

6. The device of claim 1 further including a second rotatable member that further crushes the canister after the canister has been crushed by the first rotatable member.

7. The device of claim 6 in which the second member is adapted to crush the canister against the crushing surface.

8. The device of claim 1 further including a motor operatively connected to the first rotatable member, wherein the motor drives the rotation of the first member.

9. The device of claim 8 further including a sensor operatively connected to the motor, the sensor activating the motor upon sensing the presence of the canister.

10. A device for crushing spent canisters, comprising:
a housing defining an interior region, the housing including a top wall defining an opening adapted for receiving a spent canister therethrough;
a first rotatable member having an axis of rotation and first and second engaging portions, wherein the engaging portions revolve around the axis of rotation of the first member as the member rotates;
a crushing surface adjacent to the first member; and
wherein as the first member is rotated, the first engaging portion is adapted to engage a bottom portion of the canister wall and crush the canister against the crushing surface so that the bottom portion of the canister wall is at least partially crushed inward, and as the first member further rotates, the second engaging portion is adapted to engage a top portion of the canister wall and crush the canister against the crushing surface so that the top portion of the canister wall is at least partially crushed inward.

11. The device of claim 10 further wherein the first member includes a third engaging portion, and as the first member further rotates, the third crushing portion contacts the top of the canister to further crush the canister.

12. The device of claim 11 in which the first member further includes a pushing portion that pushes the canister in a direction away from the first member after the canister has been crushed by the third engagement portion.

13. The device of claim 10 wherein the first and second engagement portions comprise spaced apart elongated shaft.

14. The device of claim 10 wherein the first and second engagement portions each comprise an edge of mating surfaces wherein the edges extend longitudinally.

15. The device of claim 10 further including a second rotatable member that further crushes the canister after the canister has been crushed by the first rotatable member.

16. The device of claim 15 in which the second member is adapted to crush the canister against the crushing surface.

17. The device of claim 10 further including a motor operatively connected to the first rotatable member, wherein the motor drives the rotation of the first member.

18. The device of claim 17 further including a sensor operatively connected to the motor, the sensor activating the motor upon sensing the presence of the canister.

19. A method of crushing a spent beverage canister, comprising:
engaging a bottom portion of canister with a first portion of a crushing member;
crushing the bottom portion so as to fold the bottom of the canister upward and toward the middle of the canister;
engaging a top portion of a canister with a second portion of a crushing member;
crushing the top portion so as to fold the top of the canister downward and toward the middle to the canister; and
further crushing the canister so that the top and bottom of the canister are further folded toward the middle portion of the canister.

20. The method of claim 19 which the further crushing the canister comprises crushing the canister so that it is substantially flat along its longitudinal dimension.
